(19) United States
(12) Patent Application Publication
(10) Pub. No.: US 2014/0211809 A1
(43) Pub. Date: Jul. 31, 2014

(54) NETWORK SWITCH WITH INTEGRATED CABLE TERMINATION LOCATIONS

(71) Applicant: CommScope, Inc. of North Carolina, Hickory, NC (US)

(72) Inventors: Ryan Enge, Dallas, TX (US); George Brooks, Allen, TX (US); G. Mabud Choudhury, Warren, NJ (US); Jeffrey Sumrall, Pearland, TX (US); Gregory Pinn, Dallas, TX (US)

(73) Assignee: CommScope, Inc. of North Carolina, Hickory, NC (US)

(21) Appl. No.: 14/243,138

(22) Filed: Apr. 2, 2014

Related U.S. Application Data
(63) Continuation of application No. 13/749,247, filed on Jan. 24, 2013.
Application No. 13/749,247 is a continuation of application No. 12/692,858, filed on Jan. 25, 2010, now abandoned.
(60) Provisional application No. 61/147,533, filed on Jan. 27, 2009.

(51) Int. Cl. H04L 12/931; H02G 1/14

(52) U.S. Cl. CPC H04L 49/604; H02G 1/14
USPC 370/401; 439/49

(57) ABSTRACT

A network switch that can directly receive and connect to telecommunications cables includes: a body; a first panel mounted to the body; a first plurality of ports located in the first panel, each of the first plurality of ports configured to receive a telecommunications cable; a second panel mounted to the body; a second plurality of ports located in the second panel, each of the second plurality of ports configured to receive a patch cord; and electronic circuitry housed in the body for conducting network switching operations, the electronic circuitry being connected with the first plurality of ports and the second plurality of ports. Such a network switch can receive a cable directly, rather than requiring an intermediate patch panel, and therefore can simplify either an interconnect or a cross-connect telecommunications system.

### RELATED APPLICATION

This application is a continuation of and claims priority to U.S. patent application Ser. No. 13/749,247, filed Jan. 24, 2013, which is a continuation of and claims priority to U.S. patent application Ser. No. 12/692,858, filed Jan. 25, 2010 which claims priority from U.S. Provisional Patent Application Ser. No. 61/147,533, filed Jan. 27, 2009, the disclosures of which are hereby incorporated herein in their entirety.

### FIELD OF THE INVENTION

The present invention relates generally to telecommunications devices, and more particularly to network switches for telecommunications devices.

Background

A conventional communications cabling “cross-connect” system, designated broadly at 10, is shown in FIG. 1, and a conventional communications cabling “interconnect” system, designated broadly at 110, is shown in FIG. 2. Many businesses, government agencies, education establishments and other organizations maintain dedicated communications networks that enable computers, printers, network servers, facsimile machines and the like to communicate with each other, and to communicate with devices in remote locations via a communications service provider. Typically, the communications network is hard-wired using communication cables that contain signal-carrying wires. In such hard-wired systems, dedicated cables are coupled to individual service ports (e.g., wall jacks) throughout, for example, a building. The cables from the dedicated service ports conventionally extend throughout a building and into one or more communications closets or computer rooms (hereinafter referred to as a “closet”).

In the illustrated embodiments, an “equipment room” (designated at 12 in FIG. 1 and at 112 in FIG. 2) is connected to and receives signals from a service provider or another building via a backbone cable, and a “telecommunications room” (designated at 14 in FIG. 1 and at 114 in FIG. 2) is connected between the equipment room and the dedicated service ports via horizontal cables. As used herein, a “backbone cable” means a cable that links multiple segments of a network. For example, backbone cables connect between floor distribution terminals, telecommunication rooms, entrance facilities, service providers, or equipment rooms within or between buildings. A backbone cable is typically terminated via IDC-punchdown connectors to a modular jack, modular patch panel or IDC patch panel. An exemplary backbone cable is the SYSTIMAX® 2091B cable, available from CommScope, Inc., Hickory, N.C. A “horizontal cable” means a cable between and including a telecommunications outlet/connector and a horizontal cross-connect system of racks and panels (also known as a “horizontal cross-connect”). A horizontal cable may also mean the cable between and including the building automation system outlet or the first mechanical termination of the horizontal connection point and the horizontal cross-connect. A horizontal cable is typically terminated via IDC-punchdown connectors to a modular jack, modular patch panel or IDC patch panel (in some environments, the terms “backbone cable” and “horizontal cable” are used interchangeably, and can be referred to as “telecommunications cables”). An exemplary horizontal cable is the SYSTIMAX® 2091B cable, available from CommScope, Inc., Hickory, N.C. A “patch cord” means a length of cable with a plug on one or both ends. These definitions are consistent with definitions of these terms as set forth in TIA/EIA 568-B.1. A “single-ended patch cord” means a length of cable with a plug on only one end. In cross-connected network environments, single-ended patch cables typically connect telecommunications equipment to the punched-down IDC terminals of a modular jack or modular patch panel or IDC patch panel. A network “switch” acts to route data to and from interconnected devices (such as individual workstations, servers, and/or other switches) and in particular addresses timing and protocol issues for interconnected devices. Typically network switches include receptacles (e.g., RJ-45 jacks) to receive patch cords that are then connected to other components. An exemplary network switch is the CATALYST 3750 switch, available from Cisco Systems, Inc., Raleigh, N.C. A “patch panel” is typically mounted to a rack or frame and includes a number of connectors (e.g., copper communications jacks or fiber optic adapters) that receive patch cords on one side and horizontal cables or single ended patch cords on the other side. Patch cords and cables can be re-arranged as the user desires to re-route signals from one piece of attached equipment to another. An exemplary patch panel is the SYSTIMAX® 360 GigaSPEED® X10D 1100 GS5 panel, available from CommScope, Inc., Hickory, N.C.

Referring now to FIG. 1, a typical cross-connect system 10 includes a series of termination ports 29 mounted on a patch panel 21 or the like on a rack 26 within the equipment room 12. One or more of the termination ports 29 receives the backbone cable 17 from the service provider or other external source. The patch panels 21 can be connected to another patch panel 16 with termination ports 15 on a second rack 13 via a patch cord 30. The ports 15 are connected to a switch 18 via a single-ended patch cord 19. The switch 18, which can direct signals based on its configuration, is connected to another patch panel 20 with termination ports 22 via a single-ended patch cord 23. The patch panel 20 is connected to a patch panel 24 mounted on the rack 26 via a patch cord 27, which spans the ports 22 and ports 25. The equipment room 12 is then connected with the telecommunications room 14 via a backbone cable 28 that connects with termination ports 63 on a patch panel 61 mounted on a rack 64 in the telecommunications room 14.

In the telecommunications room 14, the ports 63 are connected with the ports 53 of a patch panel 52 that is mounted on a rack 54 via a patch cord 58. The rack 54 also includes a switch 56 that is connected with termination ports 53 of the patch panel 52 via a patch cord 59. The switch 56 is also connected to ports 55 of other patch panels 57 via single-ended patch cords 65. These additional ports 55 are connected to patch panels 60 with termination ports 62 on the rack 64 via patch cords 66. The termination ports 62 are then connected with wall outlets 70 in work areas 68 via horizontal cables 72.

Referring now to FIG. 2, the equipment room 112 includes a rack 116 with termination ports 118 located on a patch panel 120 mounted on the rack 116, wherein the ports 118 receive a backbone cable 117 from a service provider or other external source. A switch 122 is mounted on the rack 116 and is connected to a termination port 118 with a patch cord 124. The switch is connected to a termination port 130 in a second patch panel 126 with a patch cord 128.

Referring still to FIG. 2, the equipment room 112 is connected to the telecommunications room 114 via a backbone cable 132 that is attached to a termination port 130 and to a termination port 132 of a patch panel 134 mounted on a rack 136. A switch 135 is also mounted to the rack 136 and is connected to the patch panel 134 with a patch cord 138. The switch 135 is also connected to termination ports 140 in patch panels 142 via patch cords 144. The termination ports 140 are then connected to wall outlets 146 in work areas 148 via backbone cables 150.

It may be desirable to simplify interconnect and cross-connect systems of the type discussed above.

### SUMMARY

As a first aspect, embodiments of the present invention are directed to a network switch that can directly receive and connect to telecommunications cables. The network switch comprises: a body; a first panel mounted to the body; a first plurality of ports located in the first panel, each of the first plurality of ports configured to receive a telecommunications cable; a second panel mounted to the body; a second plurality of ports located in the second panel, each of the second plurality of ports configured to receive a patch cord; and electronic circuitry housed in the body for conducting network switching operations, the electronic circuitry being connected with the first plurality of ports and the second plurality of ports. Such a network switch can receive a cable directly, rather than requiring an intermediate patch panel, and therefore can simplify either an interconnect or a cross-connect telecommunications system.

In some embodiments, the first plurality of ports comprise IDC-punchdown ports. In other embodiments, the second plurality of ports may comprise RJ-45 ports and/or fiber optic ports.

As a second aspect, embodiments of the present invention are directed to a telecommunications cabling system, comprising: a first telecommunications rack; a first network switch mounted on the first telecommunications rack, the first network switch having first and second pluralities of ports; a second telecommunications rack; a second network switch mounted on the second telecommunications rack, the second network switch having third and fourth pluralities of ports; a telecommunications cable interconnected with at least one of the first plurality of ports; a cable interconnected between at least one of the second plurality of ports and at least one of the third plurality of ports; and a patch cord interconnected with at least one of the fourth plurality of ports. Such a system can, again simplify interconnection by eliminating the need for intervening patch panels.

As a third aspect, embodiments of the present invention are directed to a network switch, comprising: a first panel; a first plurality of ports located in the first panel, each of the first plurality of ports being IDC-punchdown connectors configured to receive a telecommunications cable; a second plurality of ports, each of the second plurality of ports being RJ-45 ports and/or fiber optic adapters configured to receive a patch cord; and electronic circuitry for conducting network switching operations, the electronic circuitry being connected with the first plurality of ports and the second plurality of ports.

### BRIEF DESCRIPTION OF THE FIGURES

FIG. 1 is a schematic illustration of a layout for a conventional cabling cross-connect system.

FIG. 2 is a schematic illustration of a layout for a conventional cabling interconnect system.

FIG. 3 is a schematic illustration of a layout for a cabling connection system with a switch having termination locations according to embodiments of the present invention.

FIG. 4 is a front perspective view of the switch employed in the system of FIG. 3.

FIG. 5 is a rear perspective view of the switch employed in the system of FIG. 3.

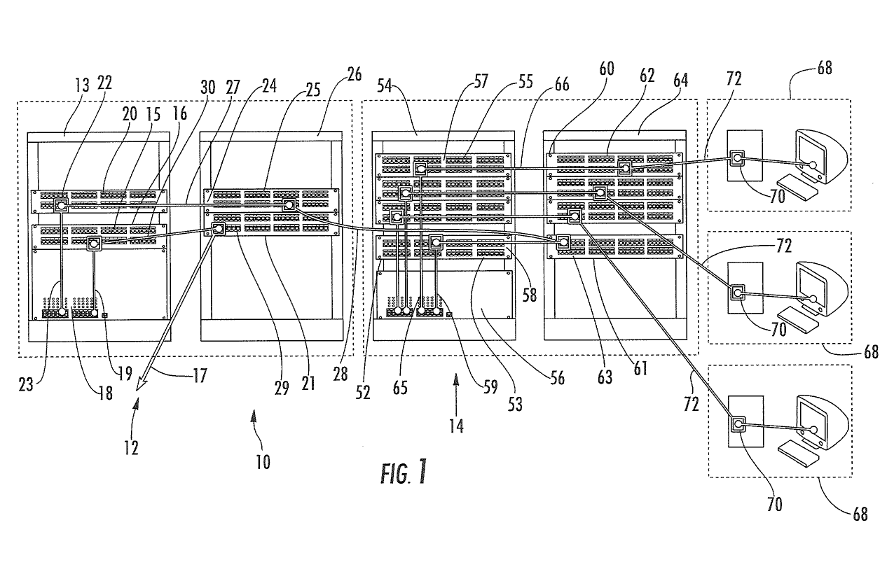

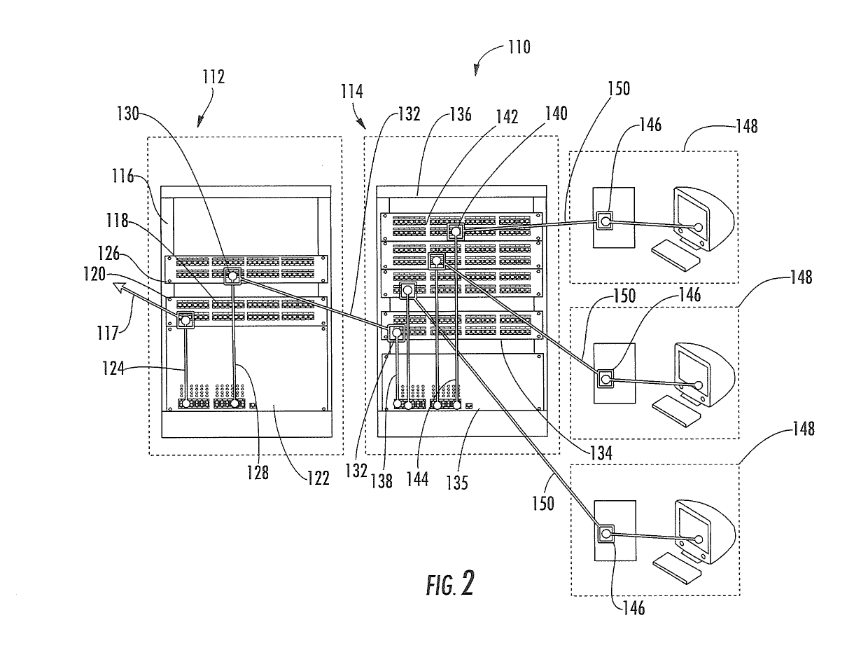

### DETAILED DESCRIPTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity. Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

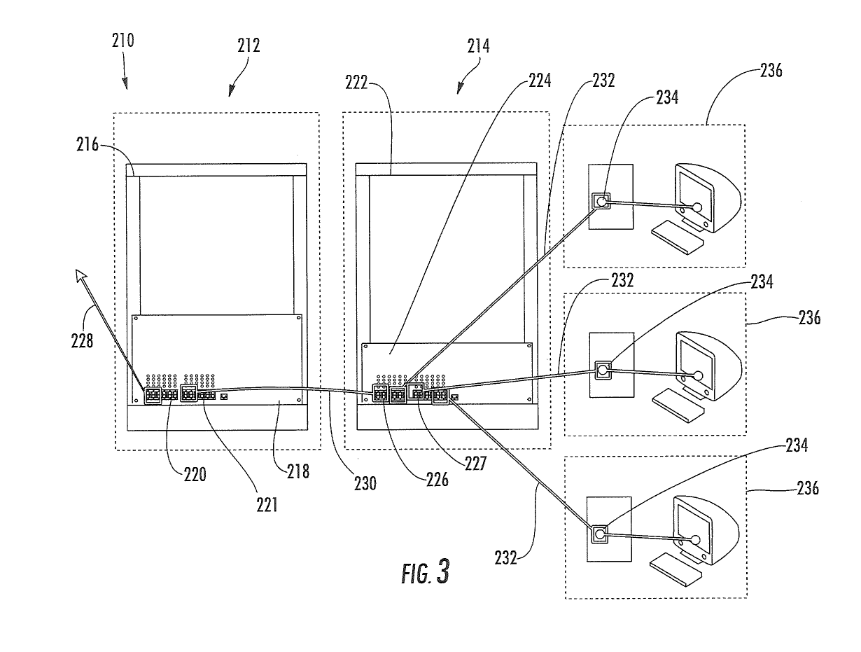

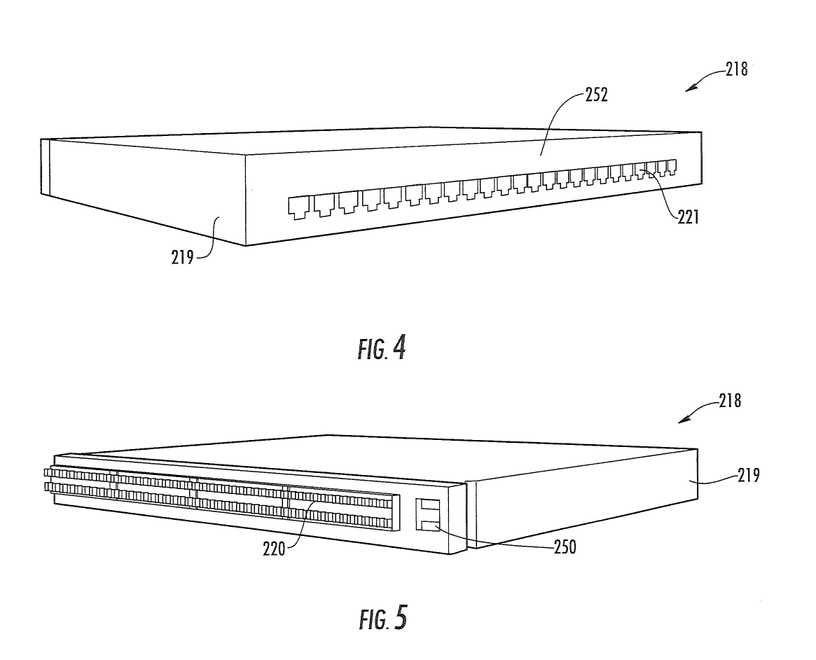

Referring now to FIG. 3, a telecommunications cabling system 210 according to embodiments of the present invention is illustrated. The system 210 is located in an equipment room 212 and a telecommunications room 214. A rack 216 in the equipment room 212 has a switch 218 with a body 219 (shown in FIG. 4) that includes termination ports 220, 221 and a rack 222 in the telecommunications room 214 has a switch 224 with a body (not shown) that includes termination ports 226, 227.

Because the switches themselves include termination ports, the racks 216, 222 need not have patch panels for the interconnection of cables entering and exiting the rooms 212, 214 (as is the case for the systems 10, 110 illustrated above). Instead, and as illustrated in FIG. 3, a backbone cable 228 that carries signals to and from the service provider or another building is connected with a termination port 220 of the switch 218. A second backbone cable 230 extends from another termination port 221 of the switch 218 to a port 226 of the switch 224. Horizontal cables 232 then connect additional termination ports 227 of the switch 224 to wall outlets 234 in work areas 236.

An exemplary switch 218 according to embodiments of the present invention is illustrated in FIGS. 4 and 5. On one side of a switch body 219, the switch 218 includes a panel 250 that has a plurality of termination ports 220. In the illustrated embodiment, the ports 220 are IDC-punchdown connectors, but in other embodiments the ports 220 may comprise ports of other configurations, such as other punchdown-style connectors. Typically, the ports 220 are configured to receive a backbone cable, such as that illustrated in FIG. 3, although in some instances a horizontal cable may include IDC-punchdown connectors. On its opposite side, the switch 218 has a panel 252 that has a plurality of termination ports 221 configured to receive a horizontal cable or patch cord. In this embodiment, the ports 221 may be RJ-45 ports, but other embodiments may comprise ports of other configurations, such as punchdown or modular plug connections, and in other embodiments, the termination ports 221 may be fiber optic adapters, such as LC or MPO adapters, Ethernet ports, or the like.

Within the body 219, the switch 218 includes electronic circuitry (not visible in FIGS. 4 and 5) connected to the panels 250, 252 that controls typical communications switching activities. The electronic circuitry is electrically connected between the ports 220 and the ports 221. Typical switching electronics process and route data packets among ports and need not be described in detail herein. Exemplary switching circuitry is described in U.S. Pat. No. 5,274,631, the disclosure of which is hereby incorporated herein. In some embodiments, the switching electronics may be in the form of a backplane, and either or both of the panels 250, 252 may connect to the backplane via a backplane connector.

Either or both of the panels 250, 252 may be permanently fixed to the body 219 (i.e., parts of a single box-type unit), or may be separable and interchanged. Also, the panels 250, 252 may be mounted on non-opposing sides of the switch body 219, or the panels 250, 252 may be included on a single contiguous panel. In some embodiments, the panel 250 is a terminal block with punchdown connectors that mates with the rear side of the body 219. The punchdown connectors may be typical punchdown connectors such as are found in conventional patch panels. The panel 252 may be a conventional switch panel, with RJ-45 ports available to receive RJ-45 connectors, as are conventionally found on one side of a network switch. Either or both of the panels 250, 252 may be subdivided into multiple termination blocks that service one or more cables. In some embodiments, the ports 220, 221 may be mounted on different portions of the same contiguous panel.

It can be seen that, by using network switches 218, 224 in the system 210, the system 210 need not have intermediate patch panels and patch cords for interconnecting signals between the equipment room and the telecommunications room. Instead, the backbone cable 228 can be connected directly to the switch 218 (rather than first to a patch panel), and the backbone cable 230 can be connected directly between the switches 218, 224 (rather than through intervening patch panels). This arrangement can be simpler and more direct than prior systems.

Those skilled in this art will appreciate that the system can be employed with either electrically conductive systems (typically using copper conductors within the cable) or fiber optic cables.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A network switch, comprising:
a body;
a first panel mounted to the body;
a first plurality of ports located in the first panel, each of the first plurality of ports configured to receive a telecommunications cable;
a second panel mounted to the body;
a second plurality of ports located in the second panel, each of the second plurality of ports configured to receive a patch cord; and
electronic circuitry housed in the body for conducting network switching operations, the electronic circuitry being connected with the first plurality of ports and the second plurality of ports.

2. The network switch defined in claim 1, wherein the first plurality of ports comprises a plurality of IDC-punchdown connectors.

3. The network switch defined in claim 2, wherein the first panel is separable from the body.

4. The network switch defined in claim 1, wherein the second plurality of ports comprises a plurality of RJ-45 ports and/or fiber optic adapters.

5. The network switch defined in claim 4, wherein the second panel is separable from the body.

6. The network switch defined in claim 1, wherein the first panel is mounted on a first side of the body, and the second panel is mounted on a second side of the body.

7. The network switch defined in claim 6, wherein the first and second sides are opposing sides.

8. The network switch defined in claim 1, wherein the first and second panels are contiguous.

9. The network switch defined in claim 1, further comprising a telecommunications cable attached to at least one of the first plurality of ports.

10. The network switch defined in claim 9, further comprising a patch cord attached to at least one of the second plurality of ports.

11. A telecommunications cabling system, comprising:
a first telecommunications rack;
a first network switch mounted on the first telecommunications rack, the first network switch having first and second pluralities of ports;
a second telecommunications rack;
a second network switch mounted on the second telecommunications rack, the second network switch having third and fourth pluralities of ports;
a telecommunications cable interconnected with at least one of the first plurality of ports;
a cable interconnected between at least one of the second plurality of ports and at least one of the third plurality of ports; and
a patch cord interconnected with at least one of the fourth plurality of ports.

12. The telecommunications cabling system defined in claim 11, wherein the first plurality of ports comprises a plurality of punchdown ports.

13. The telecommunications cabling system defined in claim 11, wherein the second plurality of ports comprises a plurality of RJ-45 ports and/or fiber optic adapters.

14. The telecommunications cabling system defined in claim 11, wherein the first plurality of ports is mounted in a first panel, and the second plurality of ports is mounted in a second panel, the first panel is mounted on a first side of the body, and the second panel is mounted on the second side of the body.

15. The telecommunications cabling system defined in claim 14, wherein the first and second sides are opposing sides.

16. A network switch, comprising:
a first panel;
a first plurality of ports located in the first panel, each of the first plurality of ports being IDC-punchdown connectors configured to receive a telecommunications cable;
a second plurality of ports, each of the second plurality of ports being RJ-45 ports and/or fiber optic adapters configured to receive a patch cord; and
electronic circuitry for conducting network switching operations, the electronic circuitry being connected with the first plurality of ports and the second plurality of ports.
